(19) United States
(12) Patent Application Publication
(10) Pub. No.: US 2011/0313561 A1
(43) Pub. Date: Dec. 22, 2011

(54) MACHINING ERROR CORRECTOR METHOD USING OPTICAL PICKUP

(75) Inventor: Jae Kwang LEE, Gyeonggi-do (KR)

(73) Assignee: SAMSUNG ELECTRO-MECHANICS CO., LTD.

(21) Appl. No.: 12/939,851

(22) Filed: Nov. 4, 2010

(30) Foreign Application Priority Data
Jun. 22, 2010 (KR) 10-2010-0059020

(51) Int. Cl. G06F 19/00

(52) U.S. Cl. 700/166

(57) ABSTRACT

Disclosed herein is a machining error corrector method using optical pickup. The machining error corrector method using optical pickup according to the present invention includes: calculating absolute coordinates by identifying alignment marks formed at edges of a plate-shaped substrate that is a workpiece to be machined by laser; storing the calculated absolute coordinates as reference position information; moving a plurality of optical pickup units according to a horizontal or vertical direction patterns formed on the plate-shaped substrate; storing the coordinates of the patterns detected by the plurality of optical pickup units as error position information; and correcting actual machining position information by comparing the reference position information with the error position information, thereby making it possible to remarkably improve the substrate machining rate using laser, or the like.

### CROSS REFERENCE TO RELATED APPLICATION

This application claims the benefit of Korean Patent Application No. 10-2010-0059020, filed on Jun. 22, 2010, entitled “Machining Error Corrector Method Using Optical Pickup,” which is hereby incorporated by reference in its entirety into this application.

### BACKGROUND OF THE INVENTION

1. Technical Field

The present invention relates to a machining error corrector method using an optical pickup, and more particularly, to a machining error corrector method using an optical pickup capable of correcting errors in laser machining coordinates of plate-shaped workpieces such as a PCB or a wafer, etc., by using the optical pickup to reduce laser machining errors, thereby making it possible to perform the precision machining using laser, etc.

2. Description of the Related Art

Generally, a sheet substrate or wafer or a plurality of substrates or wafers are transferred through a conveyor belt, etc., and are loaded in each process, during a process of manufacturing a printed circuit board (PCB) or a wafer level module. In this case, the plurality of substrates or wafers are generally loaded in each process in a flexible state. Among various processes to manufacture the substrate, the laser machining process forming vias or holes or cutting a unit substrate, etc., is provided.

When performing the laser machining process, the laser machining should be performed at an accurate position in order to minimize defective end products. Therefore, it is the most important issue to accurately calculate irradiation positions of laser for performing the laser machining.

During the laser machining, a position calculating method according to the related art recognizes alignment marks marked on a substrate at predetermined intervals from images acquired through a camera during the process of manufacturing the substrate and moves the position of the laser generator based on the recognized alignment marks to irradiate laser to a designated position, thereby performing the corresponding machining process.

However, while the process of manufacturing the substrate or the process in the wafer level state are performed, the plate-shaped workpieces are moved in the flexible state during the process, causing deformation such as warpage, drooping, twisting, etc., to occur in the substrate or the wafer. After the deformation occurs, the substrate or the wafer continuously moves to the final process in the deformed state.

Therefore, since the difference between the laser machining position and the actual position of the deformed substrate, including the above-mentioned alignment marks, occurs, the laser machining positions are changed. Further, when the laser machining positions are changed, the laser machining is performed on the positions different from the machining positions of the end product, such that the defective rate of the end product may be increased.

Meanwhile, in order to somewhat solve the problem, identification marks partitioned into the smaller space other than the alignment marks are partially identified again by displaying separate identification marks capable of dividing the plurality of unit substrates into several partitions when the warpage or drooping of the substrate occurs during the process, in addition to the alignment marks displayed on the outside of the substrate, thereby correcting the error of the laser machining positions. However, the identification marks displayed into local partitioning regions should be individually identified again and the machining errors should be calculated by using the identified information each time, such that the laser machining time is long and the entire process time of the substrate manufacturing process is long, thereby degrading the production efficiency.

### SUMMARY OF THE INVENTION

An object of the present invention is to provide a machining error corrector method using an optical pickup capable of calculating accurate laser machining positions and performing error correction using an optical pickup in real time by forming lines in horizontal and vertical directions between individual unit substrates and identifying the lines by using the optical pickup to correct errors in laser machining positions due to the deformations of the substrate in real time, thereby making it possible to improve production efficiency of products.

According to the exemplary embodiment of the present invention, there is provided a machining error corrector method using optical pickup, including: calculating absolute coordinates by identifying alignment marks formed at edges of a plate-shaped substrate that is a workpiece to be machined by laser; storing the calculated absolute coordinates as reference position information; moving a plurality of optical pickup units according to a horizontal or vertical direction pattern formed on the plate-shaped substrate; storing the coordinates of the patterns detected by the plurality of optical pickup units as error position information; and correcting actual machining position information by comparing the reference position information with the error position information.

The absolute coordinates may be used as the reference position information by simultaneously identifying identification marks partitioning individual units formed on the substrate into each predetermined region, in addition to the alignment marks formed at the edges of the substrate.

The reference position information by the absolute coordinates may be acquired through images photographed by the camera CCD on the substrate.

Preferably, the pattern formed on the substrate may be formed in a metal pattern reflecting light, and the pattern may be formed in a metal pattern formed to have three tracks parallel with each other.

The patterns may be formed along the edge portions of the substrate and may be formed in the horizontal direction and the vertical direction of the edge portions of the substrate to identify the coordinates of the pattern while each of the plurality of optical pick units moves in the horizontal direction and the vertical direction.

The pattern may be formed in plural between the individual units formed on the substrate in order to improve the recognition accuracy through the optical pickup unit.

The storing the reference position information and the error position information further includes storing each position information identified by a camera (DDC) and the optical pickup unit in a memory unit connected to the optical pickup unit, calculating error values between the reference position information and the error position information stored in the memory unit by a calculator, and allowing a controller to control a moving path of a substrate machining unit moving on the substrate by using the error value calculated through the calculator.

The substrate machining unit may be configured of a laser or mechanical drilling apparatus moving on the individual units of the substrate according to the identification information of the pattern.

At the storing the coordinates of the pattern as the error position information through the optical pickup unit, the error position information identifies the number of track bits of the pattern by light reflected from the three metal patterns to divide a signal value by which the moving distance of the optical pickup unit is converted, a focus value determining whether a focus of the pattern is matched, and a tracking value tracking the actual machining position in real time by continuously sensing the position of the pattern.

### BRIEF DESCRIPTION OF THE DRAWINGS

FIG. 1 is a plan view of a substrate capable of correcting machining errors using an optical pickup according to the present invention;

FIG. 2 is a flowchart of a machining error corrector method using an optical pickup for a substrate shown in FIG. 1;

FIG. 3 is an enlarged view of patterns formed on a substrate to which the present invention is applied;

FIG. 4 is a configuration diagram of an optical pickup unit used at the time of correcting errors according to the present invention; and

FIG. 5 is a plan view of a sensing unit used for the optical pickup unit of FIG. 4.

### DESCRIPTION OF THE PREFERRED EMBODIMENTS

The acting effects and technical configuration with respect to the objects of a machining error corrector method using an optical pickup according to the present invention will be clearly understood by the following description in which exemplary embodiments of the present invention are described with reference to the accompanying drawings.

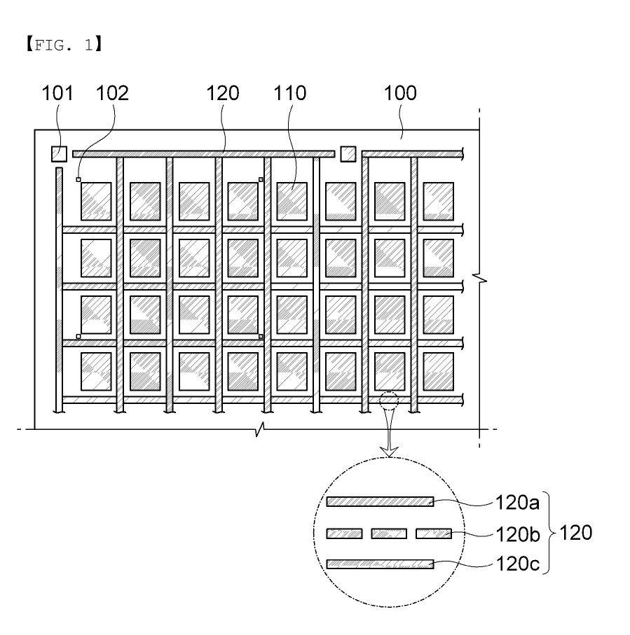

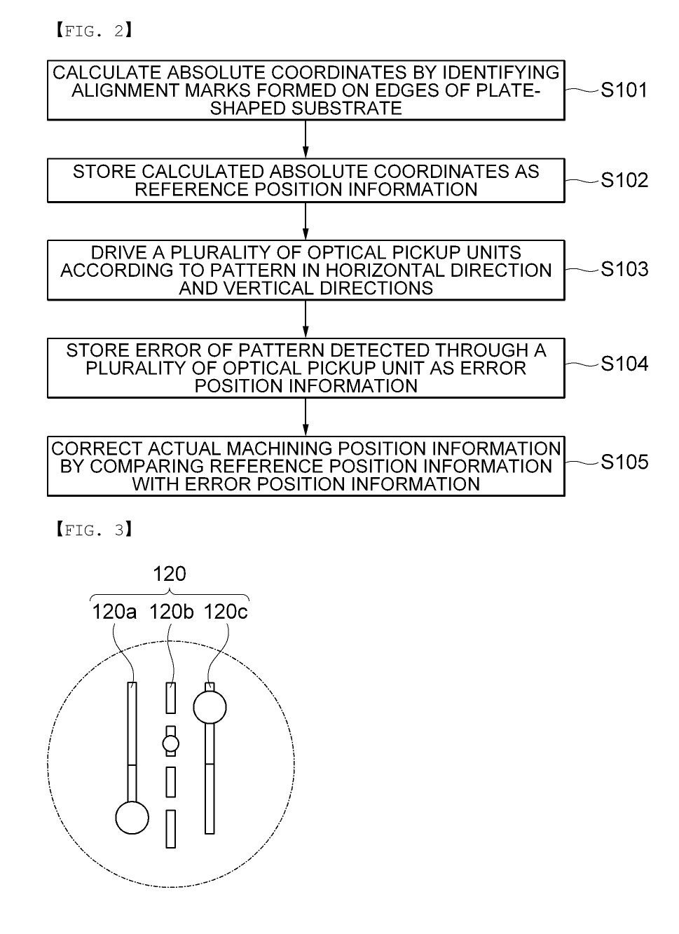

First, FIG. 1 is a plan view of a substrate capable of correcting machining errors using an optical pickup according to the present invention and FIG. 2 is a flowchart of a machining error corrector method using an optical pickup for a substrate shown in FIG. 1.

As shown in FIG. 1, a machining error corrector method according to the present invention calculates absolute coordinates by identifying alignment marks 101 formed at edges of a plate-shaped workpiece, that is, a substrate 100 (S101).

In this case, the substrate 100 is formed in a state where a plurality of individual units 110 are arranged in a line. Each edge of the substrate 100 may be provided with alignment marks 101 for aligning the substrate at a right position.

Further, identification marks 102 that divide the plurality of individual units 110 into predetermined partitions may be separately formed on the plane of the substrate 100, in addition to the alignment marks 101.

The absolute coordinates of the substrate 100 may be calculated through the alignment marks 101 formed on the substrate 100. Further, the absolute coordinates may be calculated in more detail by simultaneously identifying the separate identification marks 102 dividing the individual units 110 into predetermined partitions, in addition to the alignment marks.

At this time, the absolute coordinates calculation of the substrate 100 may be acquired through images photographed through a general camera CCD to determine the alignment positions on the substrate. Further, the absolute coordinates may be also calculated by the information identified by the optical pickup unit to be described later.

The absolute coordinates calculated from the substrate 100 may be calculated by identifying the alignment marks 101 and the identification marks 102 during the process of machining the substrate 100 using laser, etc. However, it is preferable to calculate coordinate values before the substrate is deformed as the absolute coordinates of the alignment marks 101 and the identification marks 102 before the process of the substrate 100 is transferred.

The absolute coordinates extracted from the plate-shaped substrate 100 are stored as the reference position information of the substrate in a memory unit connected to a camera photographing the substrate or the optical pickup unit to be described later (S102).

The reference position information obtained by the transformation of the absolute coordinates and stored in the memory unit is compared with the error position information extracted by the optical pickup, which is information used as a reference of the machining position before and after the substrate 100 is deformed.

Next, patterns 120 may be formed between the alignment marks 101 on the substrate 100 in horizontal or vertical directions such that the plurality of optical pickup units (not shown) are driven according to the patterns 120 in the horizontal direction and vertical direction (S103).

In this case, the pattern 120 is preferably formed as a metal pattern that can reflect light and is formed to have three tracks 120a to 120c parallel with each other, such that the pattern is identified by light reflected from the metal tracks 120a to 120c through the optical pickup unit and the tracking can be made to move the optical pickup unit according to the error position and the pattern.

The optical pickup unit will be described in more detail below with reference to the drawings.

In addition, the pattern 120 is formed on the substrate 100 in a straight line in a horizontal direction and a vertical direction, respectively. The patterns 120 may be formed along the edge portion of the substrate between the alignment marks 102 formed at the edge portion of the substrate 100 as well as a plurality of patterns 120 may be formed to intersect with each other between the plurality of individual units 110 formed on the substrate 100 in order to accurately determine the positions of the individual units 100 formed on the substrate 100 through the optical pickup unit.

As described above, the coordinates of the pattern detected by moving the plurality of optical pickup units in the horizontal or vertical directions, respectively, are stored while being transformed into the information on the error positions in the memory unit connected to the optical pickup unit in real time (S104).

In other words, when light irradiated by the optical pickup unit is sensed by being reflected from the metallic pattern 110, the number of bits of any one of the tracks 120a and 120c of the pattern 120 adjacent to the individual unit 110 formed on the substrate such that the moved position of the individual unit 100 due to the deformation of the substrate is extracted as the error position information.

In this case, the plurality of optical pickup units are individually driven according to the pattern 120 in the state deformed by light reflected and sensed from the other tracks 120a and 120c of the pattern 120 and the error position information of the individual unit 110 for the deformed degree of the substrate 100 based on the reference position information stored in the memory unit is continuously stored in the memory unit in real time while the optical pickup unit moves according to the pattern 120.

As described above, the reference position information stored in the memory unit and the error position information of each of the individual unit 110 input in real time are calculated in real time through the calculator connected to the memory unit and the moving path of the substrate machining device moving on the substrate 100 may be controlled by a controller designating the actual machining positions by applying the calculated error values.

In this case, the substrate machining unit may be configured of a laser or mechanical drilling apparatus moving on the individual unit of the substrate according to the error value obtained by calculating the identification information of the pattern obtained in the optical pickup unit.

Finally, the moving position is corrected by the changed position of the individual unit 110 on the deformed substrate according to the error value obtained by comparing the reference position information with the error position information, thereby making it possible to correct the actual machining position of the substrate machining device (S105).

The exemplary embodiment describes the entire process sequence of the machining error corrector method of the substrate, which is one of the plate-shaped workpieces, by using the optical pickup. In this case, the kind of plate-shaped workpieces is not limited to the substrate and may also include a plate-shaped wafer where holes or vias, etc., are formed at an accurate position.

When the machining error is corrected by the sequential error, the process of identifying the pattern of the substrate and the method of calculating the error value will now be described in more detail with reference to the plane configuration diagram of the optical pickup unit and the substrate identifiable through the optical pickup unit.

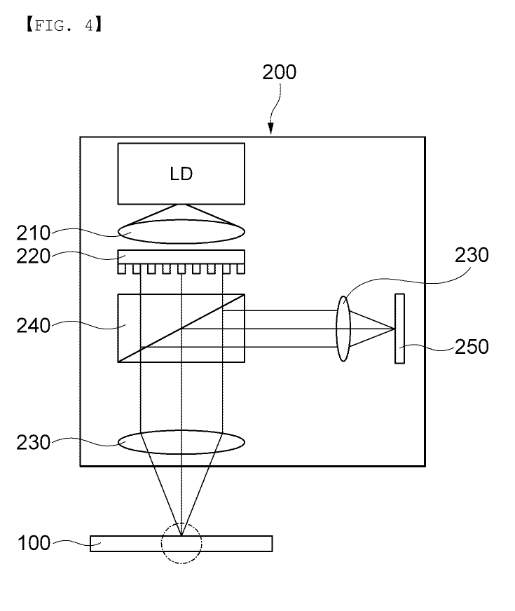

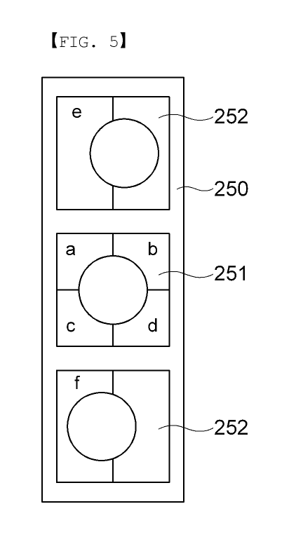

FIG. 3 is an enlarged view of patterns formed on a substrate to which the present invention is applied, FIG. 4 is a configuration diagram of an optical pickup unit used at the time of correcting errors according to the present invention, and FIG. 5 is a plan view of a sensing unit used for the optical pickup unit of FIG. 4.

As shown in the figures, an optical pickup unit 200 used for the machining error corrector method according to the present invention may be configured to include a light source (LD), a parallel light lens 210 that converts light irradiated from the light source into parallel light, a diffraction grating 220 that splits the parallel light into three beams, and a condensing lens 230 that individually condenses the split beams into the pattern 120 of the substrate 100.

In addition, the optical pickup unit 200 may further include a sensing unit 250 that receives the tracking or not and the focus and position of beam identified in the pattern 120 by reflecting the beam reflected from the pattern 120 from a beam splitter 240.

In this case, the sensing unit 250 is configured to include one 4-split CCD and two 2-spilt CCDs, such that it receives three beams reflected from the pattern 120 of the substrate 100, respectively.

The optical pickup unit 200 configured as described above converts light irradiated from the light source (LD) into the parallel light through the parallel light lens 210, splits it into three parallel beams through the diffraction grating 220 at the front thereof, and condenses the split beam into the pattern 120 of the substrate 100 through the condensing lens 230.

As described above, as the pattern 120 is divided into the three tracks 120a to 120c, three beams condensed through the condensing lens 230 are condensed into each of the tracks 120a to 120c of the pattern 120. In this case, as the pattern 120 is formed in a metal pattern to reflect the condensed light, the beam reflected from the pattern 120 is reflected from the beam splitter 240 in the optical pickup unit 200 through the condensing lens 230 and then is incident into the sensing unit 250 in a parallel light form.

Meanwhile, the sensing unit 250 includes the 2-split CCD 252 on the upper and lower portions of the 4-split CCD 251, respectively, to receive beam reflected from three tracks 120a to 120c forming the pattern 120 and converts the signal sensed in the sensing unit 250 into the electrical signal in the split regions of a, b, c, d, e, and f where each CCD is split to identify the number of bits for the tracks 120a and 120b of the pattern 120, thereby making it possible to separately receive a signal value obtained by converting the moving distance of the optical pickup unit, a focus value determining whether a focus of each track 120a and 120b of the pattern 120 is matched, and a tracking value capable of tracking the actual machining position in real time by continuously sensing the position of the pattern 120.

In this case, the signal value is received in a bit unit by dividing the pattern 120 at a predetermined interval and may be converted into the moving distance of the optical pickup unit 200 according to the number of bits stored in the memory unit. The signal value may be obtained by the sum of a, b, c, and d regions in the 4-split CCD 251.

In addition, the focus value is a signal that can determine whether the beam irradiated through the optical pickup unit 200 is accurately focused on the surfaces of each track 120a and 120b of the pattern 120, wherein the reference of the focus value represents 0 at the time of adjusting the focus and the focus value may be divided into + and − values according to the shape of beam received in the 4-split CCD 251. In this case, the focus can be adjusted by adjusting the position of the condensing lens 230 of the optical pickup unit 200 or by adjusting the position of the optical pickup unit 200.

In addition, the tracking value detected in the sensing unit 250 may be used as information that can drive the optical pickup unit 200 in a direction where the pattern 120 is formed, that is, the horizontal or vertical direction of the pattern 120 formed on the substrate 100 according to the pattern 120 and may be used means capable of determine the deformed degree of the pattern 120 in real time by the positional relationship of the focuses formed on the 2-split CCDs 252 on the upper and lower portion of the 4-split CCD 251 while the optical pickup unit 200 moves according to the pattern 120 In this case, the tracking value is obtained by the difference between e and f regions of the 2-split CCD 252. The obtained tracking value is used as the error position information, such that it compares with the reference position information, thereby making it possible to select the actual machining position.

As set forth above, the machining error corrector method using the optical pickup according to the present invention identifies the patterns in the horizontal or vertical direction formed on the substrate by the optical sensor of the optical pickup unit to track them and apply the corrected error values in order to perform the laser machining, etc., when deformation occurs during the process of manufacturing the plate-shaped workpieces such as the substrate or the wafer, etc., thereby making it possible to accurately and rapidly machine the substrate at the changed positions even when the individual unit positions of the substrate are changed.

Further, the machining error corrector method according to the present invention can identify the sensing signals in real time by identifying the patterns using the optical pickup unit and remarkably improve the substrate machining speed using laser, etc., by increasing the speed sensing the deformed degree of the patterns and the position change of the individual unit correspondingly.

Although the exemplary embodiments of the present invention have been disclosed for illustrative purposes, those skilled in the art will appreciate that various modifications, additions, and substitutions are possible, without departing from the scope and spirit of the invention as disclosed in the accompanying claims. Accordingly, such modifications, additions, and substitutions should also be understood to fall within the scope of the present invention.

What is claimed is:

1. A machining error corrector method using optical pickup, comprising
calculating absolute coordinates by identifying alignment marks formed at edges of a plate-shaped substrate that is a workpiece to be machined by laser;
storing the calculated absolute coordinates as reference position information;
moving a plurality of optical pickup units according to a horizontal or vertical direction pattern formed on the plate-shaped substrate;
storing the coordinates of the patterns detected by the plurality of optical pickup units as error position information; and
correcting actual machining position information by comparing the reference position information with the error position information.

2. The machining error corrector method using optical pickup according to claim 1, wherein the absolute coordinates are used as the reference position information by simultaneously identifying identification marks partitioning individual units formed on the substrate into each predetermined region, in addition to the alignment marks formed at the edges of the substrate.

3. The machining error corrector method using optical pickup according to claim 1, wherein the reference position information by the absolute coordinates is acquired through images photographed by the camera CCD on the substrate.

4. The machining error corrector method using optical pickup according to claim 1, wherein the pattern formed on the substrate is formed in a metal pattern reflecting light.

5. The machining error corrector method using optical pickup according to claim 4, wherein the pattern is formed in a metal pattern formed to have three tracks parallel with each other.

6. The machining error corrector method using optical pickup according to claim 2, wherein the plurality of patterns are formed along the edge portions of the substrate and are formed to intersect with each other between the individual units.

7. The machining error corrector method using optical pickup according to claim 1, wherein the storing the reference position information and the error position information further includes storing each position information in a memory unit connected to the optical pickup unit, calculating error values between the reference position information and the error position information stored in the memory unit by a calculator, and allowing a controller to control a moving path of a substrate machining unit moving on the substrate by using the error value of each position information calculated through the calculator.

8. The machining error corrector method using optical pickup according to claim 7, wherein the substrate machining unit is a laser or mechanical drilling apparatus moving on the individual units of the substrate according to the position information identified by the pattern.

9. The machining error corrector method using optical pickup according to claim 5, wherein at the storing the coordinates of the pattern as the error position information through the optical pickup unit, the error position information identifies the number of track bits of the pattern by light reflected from the three tracks configuring the pattern to divide a signal value by which the moving distance of the optical pickup unit is converted, a focus value determining whether a focus of the pattern is matched, and a tracking value tracking the actual machining position in real time by continuously sensing the position of the pattern.
